(19) United States
(12) Patent Application Publication
(10) Pub. No.: US 2007/0014972 A1
(43) Pub. Date: Jan. 18, 2007

(54) Casing made of wooden material, and method for processing wooden material

(75) Inventor: Tatsuya Suzuki, Tokyo (JP)

Correspondence Address: HOGAN & HARTSON L.L.P., 1999 AVENUE OF THE STARS, SUITE 1400, LOS ANGELES, CA, 90067, US

(73) Assignee: OLYMPUS CORPORATION

(21) Appl. No.: 11/180,877

(22) Filed: Jul. 13, 2005

(51) Int. Cl. B32B 1/00

(52) U.S. Cl. 428/174

(57) ABSTRACT

A wooden casing is provided with a conductive pattern formed on the surface of the wooden material by carbonizing the surface thereof. A method for processing a surface of a wooden material, is provided with the steps of carbonizing the surface of the wooden material, and compressing the wooden material.

### BACKGROUND OF THE INVENTION

1. Field of the Invention

The present invention relates to a wooden casing which can be used as, for example, a covering member of an industrial product, and to a method for processing the surface of a wooden material.

2. Description of Related Art

Conventionally, as materials for a casing of electronic apparatuses such as, for example, a digital camera, a portable telephone set, IC recorder, etc., and electric appliances, light metals (for example, aluminum, stainless steel, titanium, magnesium) and synthetic resins (for example, ABS, polycarbonate, acrylic) have mainly been used based on functional aspects such as formability, corrosion resistance, etc., and a design aspect. However, when evaluated as a covering member, the casings made of such materials have some shortcomings and problems in that no originality is brought about because there is almost no difference among individual casings, and design is spoiled by flaws and discoloration developing over long-term use.

Additionally, light metals and synthetic resins have a shortcoming that they give users a sense of coldness or cheapness even through they have high strength.

Therefore, the inventor of the present application has focused his attention on construction of casings using a wooden material. The reasons reside in that various advantages are brought about, for example, various grains of a wooden material present appropriate individual differences, and the design is improved owing to changes in hues of the surface of the casing over long-term use.

In addition, another reason resides in that a wooden material becomes familiar to the hands of a user through use, and gives the user a gentle sense of touch.

However, where a wooden material is employed for a casing of an electronic device as described above, it is considered that rigidity of the casing is lower in comparison with a case where light metals or synthetic resins are used. In order to compensate lower rigidity, it is considered that the thickness of a wooden material is increased. However, an increase in the thickness is not proper for the casing of an electronic device which is required to be downsized.

Conventionally, a processing method to increase the strength of a wooden material by compressing the wooden material has been publicly known. With the method, a wooden material is caused to absorb water to be softened, and compressed while being deformed to a predetermined shape, and then sliced in the compression direction to obtain a plate-shaped primary fixed product. Then, a formed product having a predetermined three-dimensional shape is formed by causing the primary fixed product to absorb water while being heated. The shape of the formed product is fixed to obtain a final product (for example, refer to Japanese Patent No. 3078452). Further, a method for compressing and fixing a wooden material in a softened state has been known (for example, refer to Japanese Unexamined Patent Application, First Publication No. H11-77619).

Further, a method for carbonizing the surface of a wooden material using a gas burner to improve durability, corrosion resistance and insect proofing of a wooden material has been known (for example, Japanese Examined Patent Application, Second Publication No. S37-4437).

### SUMMARY OF THE INVENTION

A wooden casing of the present invention includes a conductive pattern formed on a surface of a wooden material by carbonizing the surface of the wooden material.

In the wooden casing of the present invention, it is preferable that electric components be connected to the conductive pattern.

In the wooden casing of the present invention, it is preferable that a through-hole passing through the wooden material from one side of the wooden material to the other side thereof be formed in the wooden material, the electronic components disposed on one side of the wooden material be electrically connected to the conductive pattern formed on the other side of the wooden material through the through-hole.

In the wooden casing of the present invention, it is preferable that the wooden material be compressed.

A method for processing the surface of a wooden material of the present invention includes the step of carbonizing the surface of the wooden material and the step of compressing the wooden material.

In the method for processing the surface of a wooden material of the present invention, it is preferable that the step of carbonizing be carried out simultaneously with or after the step of compressing, and a conductive pattern may be formed on the surface of a wooden material by carbonizing the surface of the wooden material. Further, it is preferable that the step of compressing be carried out after the step of carbonizing so that a concavity and convexity due to woodgrains which is produced by carbonizing, may be made even.

In the method for processing the surface of a wooden material of the present invention, it is preferable that the surface of the wooden material be made smooth through the step of compressing.

In the method for processing the surface of a wooden material of the present invention, it is preferable that an optional convex and concave pattern be given to the surface of the wooden material through the step of compressing.

### BRIEF DESCRIPTION OF THE DRAWINGS

FIG. 1 is a perspective view showing an electronic device using a wooden casing according to a first embodiment of the present invention.

FIG. 2 is an exploded perspective view of the electronic device shown in FIG. 1.

FIG. 3 is a sectional view taken along the line A-A of the electronic device shown in FIG. 1.

FIG. 4 is a front elevational view of an inner surface of a main surface part of the wooden casing according to the first embodiment, on which a ground line and current lines are formed.

FIG. 5 is a longitudinal sectional view depicting a connection structure between the ground line and electronic components of the electronic device shown in FIG. 1.

FIG. 6 is a longitudinal sectional view depicting an another connection structure between the current lines and electronic components of the electronic device shown in FIG. 1.

FIG. 7 is a perspective view depicting shaping of a wooden material to make the wooden casing according to the first embodiment.

FIG. 8 is a perspective view depicting a compression step of a wooden material according to the first embodiment.

FIGS. 9, 10, 11 and 12 are longitudinal sectional views depicting respective compression steps of a wooden material for making the wooden casing according to the first embodiment.

FIG. 13 is a perspective view depicting respective steps of a method for processing the surface of a wooden material according to a second embodiment of the present invention, wherein (a) depicts a wooden material before being processed, (b) depicts a wooden material after being roughly processed, (c) depicts a wooden material in the carbonizing step, and (d) depicts a wooden material after being compressed.

FIG. 14 is an explanatory view depicting conditions of a compression process in the method for processing the surface of a wooden material according to the second embodiment of the present invention.

FIG. 15 is an explanatory view depicting the conditions of compressing the wooden material using dies in FIG. 14.

FIG. 16 is an explanatory view depicting the conditions of the wooden material taken out of the dies shown in FIG. 15 after the compression process.

FIG. 17 is an explanatory view depicting the relevant parts of the dies used for the method for processing the surface of a wooden material according to a third embodiment of the present invention.

FIG. 18 is an explanatory view depicting the conditions of the wooden material taken out of the dies shown in FIG. 17 after the compression process.

FIG. 19 is an explanatory view depicting the relevant parts of the dies used for the method for processing the surface of a wooden material according to a fourth embodiment of the present invention.

FIG. 20 is an explanatory view depicting the relevant parts of the dies used for the method for processing the surface of a wooden material according to a fifth embodiment of the present invention.

### DESCRIPTION OF THE PREFERRED EMBODIMENTS

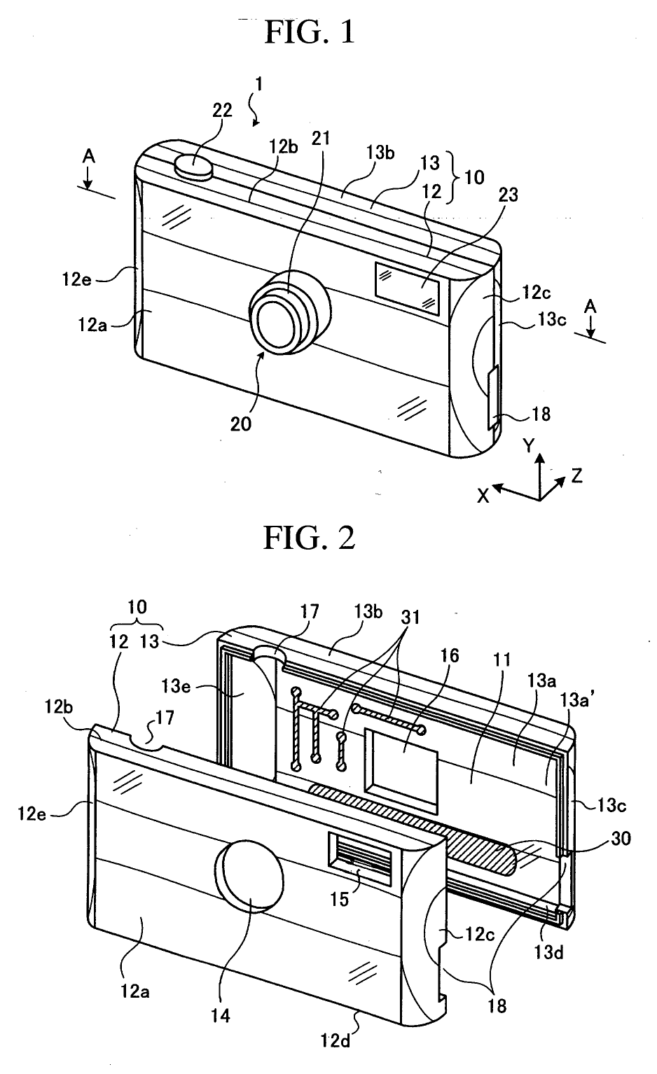

Hereinafter, a detailed description is given of a first embodiment of the present invention with reference to FIG. 1 through FIG. 12.

First, the fundamental concept of the present invention will be described. The present invention relates to a structure of a casing for holding electronic components in a space sectioned and formed with a wooden material. Herein, the number and shape of the wooden materials that form a casing are optional. Further, a detailed specification of electronic components disposed in the interior of the casing is also optional. In the following embodiments, a description is given of an example in which a casing for holding electronic components for a digital camera is constructed by using two plates of wooden material. Furthermore, a method for forming a wooden material is optional, wherein a non-compressed wooden material and a compressed wooden material may be used. In the following embodiments, a description is given of an example in which the casing is composed of compressed wooden materials.

The present invention is featured in that a conductive pattern is provided on the inner surface of a wooden material by carbonizing the inner surface. Although a wooden material is an insulative member, since it becomes conductive when it is carbonized, the carbonized portion is utilized as a conductive pattern, whereby it is possible to form the entirety or a part of the circuit pattern, which have been conventionally formed on a substrate, on the inner surface of a wooden material. By forming the entirety or a part of the circuit pattern on the inner surface of the wooden material, since the substrate can be made small, resultantly, the entirety of electric components can be downsized. In addition, since electronic components that have been usually electrically connected to a conductive path on a substrate can be connected to the casing, the degree of freedom for disposing electronic components can be increased.

Next, a description is specifically given of an embodiment of a wooden casing of the present invention. However, the present invention is not limited to this embodiment.

(Outline of an Electronic Device)

FIG. 1 is a perspective view of an electronic device using a wooden casing. As shown in FIG. 1, the electronic device 1 is a digital camera, which is provided with a casing 10 and an electronic portion 20. The electronic portion 20 is accommodated in the space 11 inside of the casing 10. The casing 10 holds the electronic portion 20 integrally therewith, and simultaneously protects the electronic portion 20. Further, the casing 10 has its outer surface exposed to the exterior, and is caused to function as a covering member of the electronic device 1.

The electronic portion 20 causes the electronic device 1 to achieve predetermined electronic features. The electronic portion 20 is provided with, for example, a pickup lens 21, a shutter button 22, a strobe 23, a liquid crystal display monitor, a pickup device, drive circuits of various types of devices, and terminals for connection with peripheral devices, etc. Note that, FIG. 1 depicts only the pickup lens 21, shutter button 22 and strobe 23 of the electronic portion 20.

In the following description, as shown in FIG. 1, it is assumed that the X direction along the lengthwise direction of the electronic device 1 is designated the lengthwise direction, the Y direction along the widthwise direction and orthogonal to the lengthwise direction is designated the widthwise direction, and the Z direction orthogonal to both the lengthwise direction and the widthwise direction is designated the thickness direction. Also, it is assumed that the dimension in the lengthwise direction is designated a lengthwise dimension, the dimension in the widthwise direction is designated a widthwise dimension, and the dimension in the thickness direction is designated a thickness.

(Construction of the Casing)

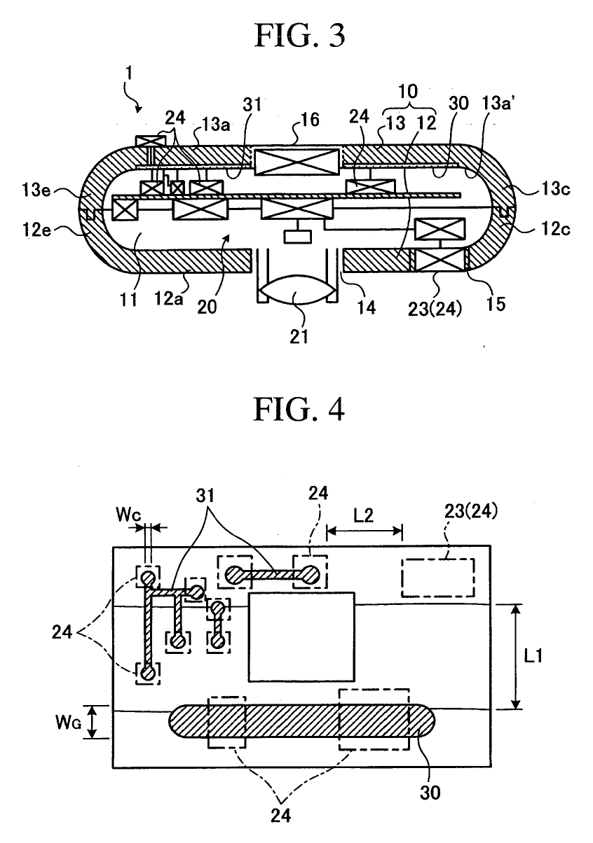

Next, a description is given of a detailed structure of the casing 10. FIG. 2 is an exploded perspective view (with the electronic portion omitted) of the electronic device of FIG. 1, and FIG. 3 is a sectional view taken along the line A-A of the electronic device of FIG. 1. As shown in FIG. 2 and FIG. 3, the casing 10 is composed by combining a plurality of compressed wooden materials. In detail, the casing 10 is composed by combining the front part panel 12 and the rear part panel 13, which are a pair of compressed wooden materials. The front part panel 12 is integrally provided with a flat plate-shaped main surface part 12a and side surface parts 12b through 12e formed at the circumference of the main surface part 12a. The rear part panel 13 is integrally provided with a flat plate-shaped main surface part 13a and side surface parts 13b through 13e formed at the circumference of the main surface part 13a.

The front part panel 12 and the rear part panel 13 are processed and formed so as to match the shapes of objects to be held inside thereof. That is, the front part panel 12 includes a lens opening 14 for exposing a pickup lens 21 to the exterior, and a strobe opening 15 for exposing a strobe 23 to the exterior. The rear part panel 13 includes a monitor opening 16 for exposing a liquid crystal display monitor. Further, each of the front part panel 12 and the rear part panel 13 includes a shutter opening 17 for exposing the shutter button 22 and a terminal opening 18 for permitting the connection terminal to be connected to a peripheral device.

(Outline of a Conductive Pattern)

As shown in FIG. 2 and FIG. 3, a ground line 30 and a plurality of current lines (conductive pattern) 31 are formed on the inner surface 13a′ (the surface facing the space 11) of the main surface part 13a of the rear part panel 13. The ground line 30 and the current lines 31 are briefly formed by heating and carbonizing the inner surface 13a′, wherein the carbonizing causes conductivity to be given to the same. As shown in FIG. 3, various types of electronic components 24 that construct the electronic portion 20 are electrically connected to the ground line 30 and the current lines 31 and display predetermined features with a current passing through the ground line 30 and the current lines 31.

The locations where such a ground line 30 and current lines 31 are formed may be optionally determined. For example, the ground line 30 and the current lines 31 may be disposed corresponding to the electronic components 24. Further, the electronic components 24 may be disposed corresponding to the ground line 30 or the current lines 31.

In addition, the shape and thickness of the ground line 30 and the current lines 31 may be optionally determined. The ground line 30 and the current lines 31 are formed in such a shape and a thickness that they can secure at least required conductivity. For example, where the electrical resistance per unit sectional area of the ground line 30 or the current line is higher than that of a copper foil in a conventional printed circuit board, the line width and thickness of the ground line 30 and the current lines 31 are increased corresponding to the resistance ratio of the two, whereby the electrical resistance of the ground line 30 and each current line 31 as a whole can be made equivalent to the electrical resistance of the entirety of the conventional copper foil.

(Details of the Ground Line)

FIG. 4 is a front elevational view depicting the inner surface of the main surface part on which the ground line and the current lines are formed. In FIG. 4, images of the respective electronic components 24 connected to the ground line 30 and the current lines 31 which are projected onto the inner surface of the main surface part are illustrated by using virtual lines. The ground line 30 is a conductive path that supplies a common reference potential to the electronic components 24. The ground line 30 is made long in the lengthwise direction of the main surface part and is formed to be wide, so that the ground line 30 can be easily connected to a number of electronic components 24. For example, the line width W_{G} of the ground line 30 is larger than the line width W_{C} of the current lines 31.

(Details of the Current Lines)

The current lines 31 are conductive paths to make the electronic components 24 conductive to each other. In particular, the current lines 31 flow a comparatively large amount of currents such as drive currents, etc., of the electronic components 24. A plurality of current lines 31 are provided at a plurality of positions corresponding to a plurality of electronic components 24, and form a pattern corresponding to a conductive pattern of the plurality of electronic components 24.

(Insulation Property from the Conductive Pattern)

Required insulation performance is secured by disposing the ground line 30 and the current lines 31 distant from the electronic components 24 by predetermined insulation distance. For example, in order to cause a Xenon gas in a discharge tube (not shown) to be subjected to ionization discharge, a high-voltage current must flow through a trigger electrode (not shown) of the strobe 23. The ground line 30 is disposed with an insulation distance L1 kept from the strobe 23, and the current lines 31 are disposed with an insulation distance L2 kept from the strobe 23, so that no current may leak from the ground line 30 and the current lines 31 even in a case where a high voltage is thus applied to the trigger electrode. Detailed values of the insulation distances L1 and L2 are determined while taking the voltage at high voltage portions and electrical resistances of the ground line 30 and the current lines 31 into consideration. Also, further insulation may be secured by disposing an optional insulator between the ground line 30 and the high voltage portion or the current lines 31 and the high voltage portion, as necessary.

(Connection Structure Between the Conductive Pattern and Electronic Components)

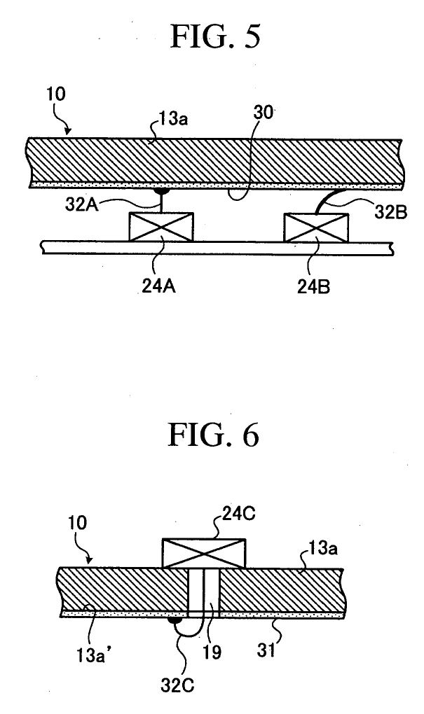

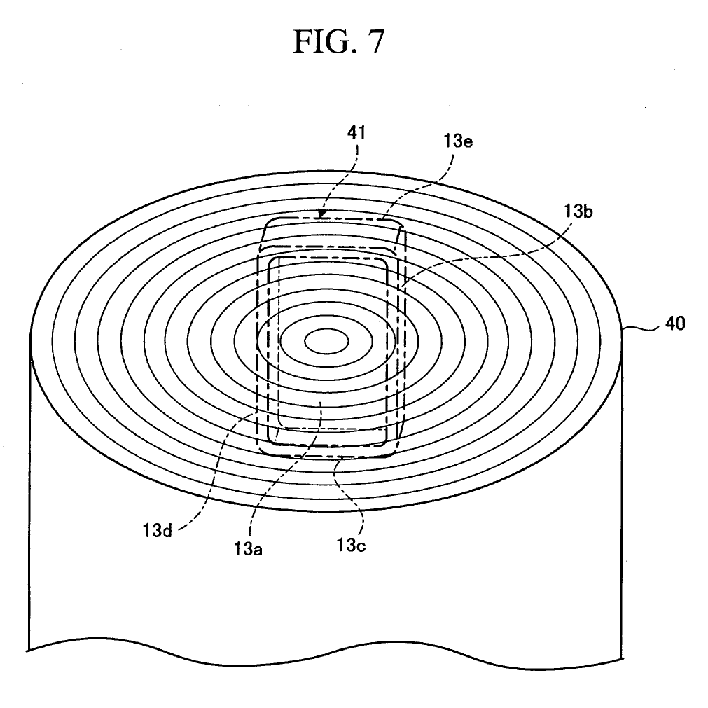

FIG. 5 is a longitudinal sectional view depicting a connection structure between the ground line and an electronic component, and FIG. 6 is a longitudinal sectional view depicting a connection structure between the current lines and an electronic component. As shown in FIG. 5, the electronic component 24A is connected to the ground line 30 via a lead wire 32A, and an electronic component 24B is connected to the ground line 30 via a lead wire 32B. The lead wire 32A extending from the electronic component 24A is connected to the ground line 30 by soldering, etc., whereby stable conductivity is brought about. On the other hand, the lead wire 32B extending from the electronic component 24B is connected to the ground line 30 while it protrudes toward the ground line 30 and is brought into contact therewith in an unfixed state. According to such a way of connecting, since no soldering work is required, it is possible to further easily carry out assembling and disassembling of the casing 10.

As shown in FIG. 6, the electronic component 24C is provided on the outer surface of the main surface part 13a, and is connected to the current line 31 via a lead wire 32C. In detail, a through-hole type opening 19 is formed in the main surface part 13a from its outer surface to its inner surface 13a′, and the lead wire 32C is inserted into the opening 19. An electronic component 24C is connected to the current line 31 by soldering the lead wire 32C to the electronic component 24C and the current line 31. According to such a way of connecting, since it is possible to connect the electronic component 24C at the exterior of the casing 10 to the current line 31 inside the casing 10, it is possible to further increase the degree of freedom with respect to disposing the electronic component 24A. In addition, the connection structure applied to the ground line 30 may be applied to the current lines 31, and the connection structure applied to the current lines 31 may be applied to the ground line 30.

(Method for Forming the Rear Part Panel)

Next, a description is given of a method for forming the rear part panel 13. Note that, the front part panel 12 may be formed as well by omitting a carbonizing step described later. FIG. 7 is a perspective view depicting shaping of a wooden material in this embodiment. As shown in FIG. 7, first, a piece of a wooden material 41 is shaped from a raw wood 40 which is not compressed yet. The wooden material 41 is integrally provided with the main surface part 13a and side surface parts 13b through 13e, which are caused to communicate with each other through smooth curved surfaces.

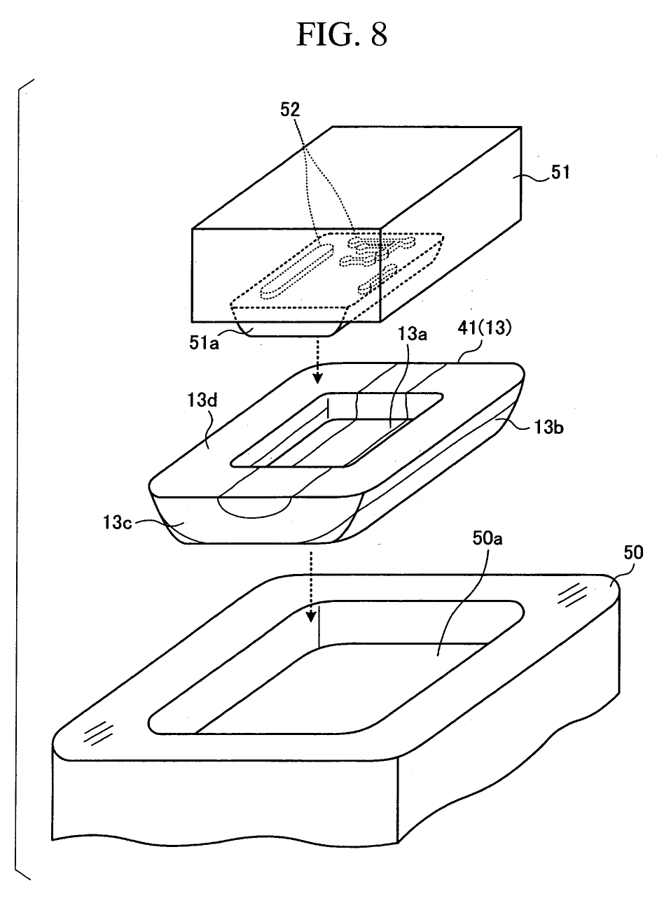

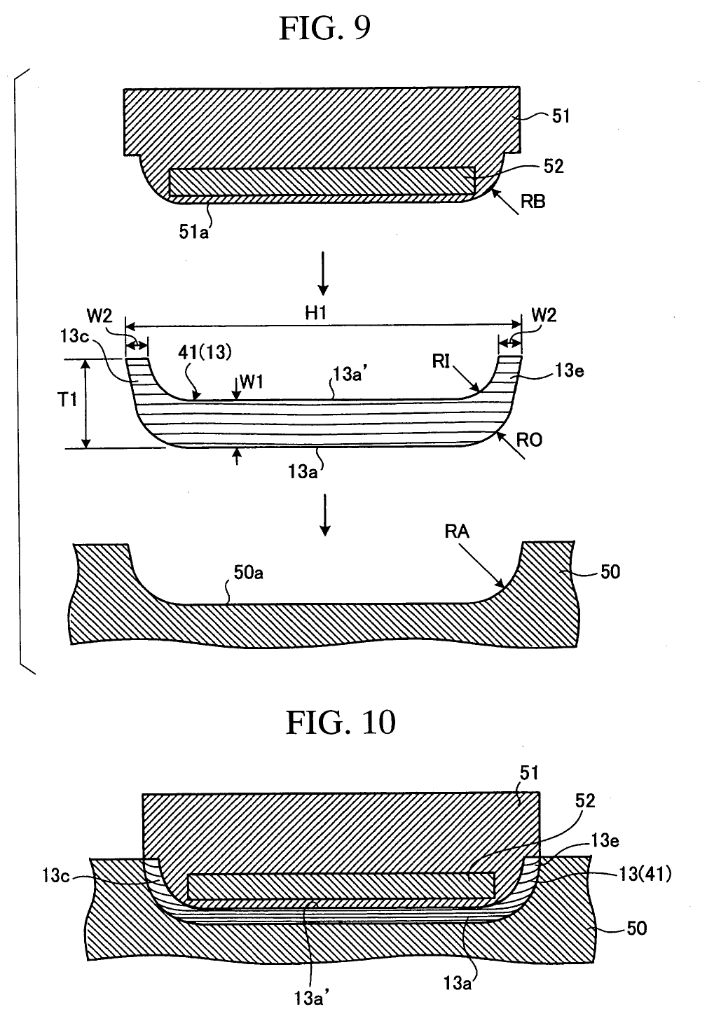

FIG. 8 is a perspective view depicting a compression step of a wooden material according to this embodiment. FIG. 9 through FIG. 12 are longitudinal sectional views depicting respective compression steps of a wooden material according to this embodiment. Briefly, as shown in FIG. 8, the wooden material 41 is pressed between a lower die 50 and an upper die 51, whereby the rear part panel 13, which is integrally provided with the main surface part 13a and the side surface parts 13b through 13e, is formed.

First, a description is given of a shape of the wooden material 41. The wooden material 41 is shaped while a volume decreased by the compression is previously added. In detail, as shown in FIG. 9, the main surface part 13a and each of the side surface parts 13b through 13e are, respectively, shaped so that the former has a thickness W1 in which the volume decreased by the compression is previously added, and the latter has a thickness W2 and a height T1 in which the volume decreased by the compression is previously added. Also, FIG. 9 depicts only the side surface parts 13c and 13e. The entirety of the wooden material 41 is shaped so as to have a width H1. In addition, the main surface part 13a is formed to be thicker than each of the side surface parts 13b through 13e. That is, the thickness W1 of the main surface part 13a is larger than the thickness W2 of each of the side surface parts 13b through 13e.

The radius of curvature of the curved surface RO on the exterior side surface of the wooden material 41 is larger than the radius of curvature of the curved surface RA of a recess 50a of the lower die 50 opposed to the curved surface RO. On the other hand, the radius of curvature of the curved surface RI of the wooden material 41 is larger than the radius of curvature of the curved surface RB of a projection 51a of the upper die 51. Further, as shown in FIG. 10, a space sectioned between the lower die 50 and the upper die 51, where they are combined together, takes the shape of the rear part panel 13 after compression of the wooden material 41.

As shown in FIG. 8 through FIG. 11, a heating portion 52 is provided in the interior of the projection 51a of the upper die 51. The heating portion 52 is heating device that forms the ground line 30 and the current lines 31, by heating and carbonizing the inner surface 13a′ of the wooden material 41 via the projection 51a. As shown in FIG. 8, the heating portion 52 is disposed at a position corresponding to the ground line 30 and the current lines 31 and takes the shape corresponding to the ground line 30 and the current lines 31.

(Specific Example of a Method for Forming the Front Part Panel and Rear Part Panel)

As shown in FIG. 9, the wooden material 41 is disposed between the lower die 50 and the upper die 51. At the same time, the wooden material 41 is placed in an atmosphere of water vapor under high temperature and high pressure for a predetermined period of time, wherein the wooden material 41 excessively absorbs moisture and is softened. Next, as shown in FIG. 10, the wooden material 41 is compressed by fitting the upper die 51 into the lower die 50 (Compression step). The wooden material 41 is left as it is with a compressive force applied thereto, for a predetermined period of time. Then, an atmosphere of water vapor under high temperature and high pressure is released.

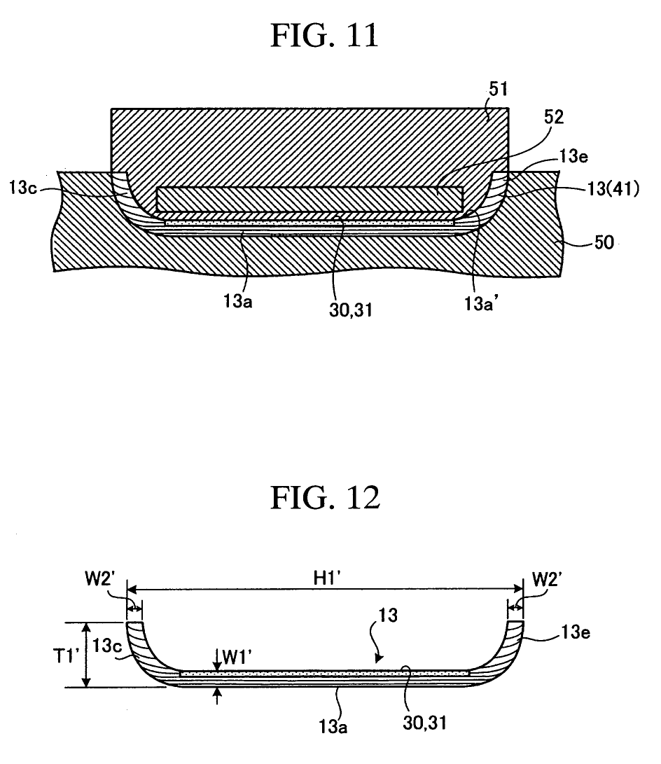

After that, as shown in FIG. 11, the wooden material 41 is heated by the heating portion 52, and the inner surface 13a′ of the wooden material 41 is carbonized to form the ground line 30 and the current lines 31 (Carbonizing step). Although the heating temperature is optional at this time, since it is known that the electrical resistance of the carbonized portion changes in accordance with the degree of carbonization, it is preferable that the wooden material 41 be heated to an adequate temperature at which predetermined electrical resistance can be obtained.

After the ground line 30 and the current lines 31 are thus formed, the upper die 51 is separated from the lower die 50, and, as shown in FIG. 12, the rear part panel 13 which is formed by the lower die 50 and the upper die 51 is taken out. Through the above-described procedure, formation of the rear part panel 13 is completed. The rear part panel 13 which has been formed is compressed so that the thickness of the main surface part 13a and each of the side surface parts 13b through 13e is made into W1′ and W2′, respectively, which are almost uniform, and each of the side surface parts 13b through 13e is compressed so that the height thereof is made into T1′. Likewise, the rear part panel 13 is compressed so as to have a width H1′ as the entirety. Since the rear part panel 13 thus compressed and formed increases its wooden fiber density, the strength of the entirety of the rear part panel 13 is made higher. According to the manufacturing method described above, it is possible to compress a wooden material and to form the ground line 30 and the current lines 31 by a single step of formation using a set of dies.

In the above, a description has been given of the embodiment of the present invention. However, a detailed configuration and method of the present invention may be subjected to optional modifications and improvements within the scope of the technical thought of the respective aspects described in the scope of claims. Hereinafter, a description is given of such modification examples.

The electronic device 1 is not limited to a digital camera. It may be a portable telephone, an IC recorder, a PDA, a portable television set, a portable radio set, and remote controllers of various types of household appliances.

The number of wooden materials, which compose the casing 10, is optional. For example, the electronic component 24 may be housed in the interior of a single plate of a wooden material, or two to four plates of wooden materials may be combined. Further, the shape of a wooden material and the shape of the casing 10 composed by a combination of a plurality of wooden materials are optional. For example, the casing 10 may be composed to be cylindrical or oval-shaped.

The method for forming a compressed wooden material is not limited to the method described above. For example, forming of the side surface parts 12b through 12e and 13b through 13e may be carried out simultaneously with the compression step by pressing the wooden material 41 which is cut off to be flat plate-shaped with a set of dies. In addition, the compression direction of the wooden material 41 may be set in a direction other than the above-described direction, or the compression may be carried out in a plurality of different directions.

In the embodiment described above, although the ground line 30 and current lines 31 are formed only at a part of the inner surface 13a′ of the main surface part 13, these lines may be formed on the entirety of the inner surface 13a′, the main surface part 12a of the front part panel 12, the side surface parts 12b through 12e of the front part panel 12, the side surface parts 13b through 13e of the rear part panel 13, or the outer surface of the casing 10. Further, a plurality of ground lines may be provided, and a plurality of current lines 31 may be integrated into one line. In the embodiment described above, the ground line 30 and the current lines 31 are formed linear. However, these lines may be formed in any optional shape, for example, a curved line, a spot, and a plane. The conductive pattern may include features other than as the ground line 30 and the current lines 31. For example, the conductive pattern may be used as a signal line for communications of various types of signals. However, in a case where it is likely that the electrical resistance brought about by carbonization is not made sufficiently uniform and a minute current cannot be transmitted with necessary accuracy, it is preferable that the conductive pattern be used only as the ground line 30 and the current lines 31.

The carbonizing step may be carried out not only after the compression step but also simultaneously with the compression step. For example, the wooden material 41 may be heated by the heating portion 52 secured in the upper die 51 at the same time as the wooden material 41 is pressed by the upper die 51. In this case, it is possible to shorten the production time in comparison with a case where the carbonizing step is carried out after the compression step is completed. However, there is a possibility that the surface of the wooden material 41 is hardened in line with the carbonization, and the wooden material does not bear the compressive force and is subjected to breakage. In such a case, as in the embodiment described above, it is preferable that the carbonizing step be carried out after the compression step is completed.

Further, the carbonizing step may be carried out by various types of means other than the heating portion 52 secured in the upper die 51. For example, after the wooden material 41 is pressed by the upper die 51 and the upper die 51 is separated from the compressed wooden material, the heating portion 52 provided independently from the upper die 51 may be pressed to the inner surface 13a′ for carbonization. Furthermore, after the upper die 51 is separated from the compressed wooden material, a laser may be irradiated onto the inner surface 13a′ by a laser unit such as a pulse laser. In particular, since the shape and thickness of a conductive pattern can be more accurately controlled if the surface of the wooden material 41 is carbonized by using such a laser unit, it is preferable to use such a laser unit.

As described above, a wooden casing of this embodiment is useful in view of forming a conductive path for electronic components on a wooden material. In particular, the casing is suitable for increasing space efficiency and degree of freedom when disposing the conductive path.

According to the wooden casing of this embodiment, since conductivity of electronic components can be secured via a conductive pattern formed on the inner surface of a wooden material, a printed circuit board can be downsized. As a result, it is possible to downsize the entirety of a casing in which printed circuit boards are housed. Further, a conductive path can be formed at a position separate from a printed circuit board. As a result, the degree of freedom for disposing electronic components can be increased.

To utilize the casing as a conductive path, it is considered that the casing is formed of metal or resin including metal, or a metal piece is adhered to a part of the casing formed of resin. However, the former case is not preferable in that insulation becomes difficult since the entirety of the casing is conductive. Also, the latter case is not preferable since it becomes time-consuming to produce the casing. To the contrary, according to the present invention, since a conductive pattern can be formed on a part of a wooden material which is an insulative member, the insulation can be easily secured. In addition, a conductive pattern can be formed integral with a wooden material. As a result, it is possible to easily produce the casing.

According to the wooden casing of this embodiment, the conductive pattern and electronic components can be made electrically conductive.

According to the wooden casing of this embodiment, electronic components disposed at the exterior of the casing can be connected to a conductive pattern provided in the interior of the casing. As a result, it is possible to further increase the degree of freedom for disposing the electronic components.

According to the wooden casing of this embodiment, it is possible to increase the rigidity of the casing by using a compressed wooden material.

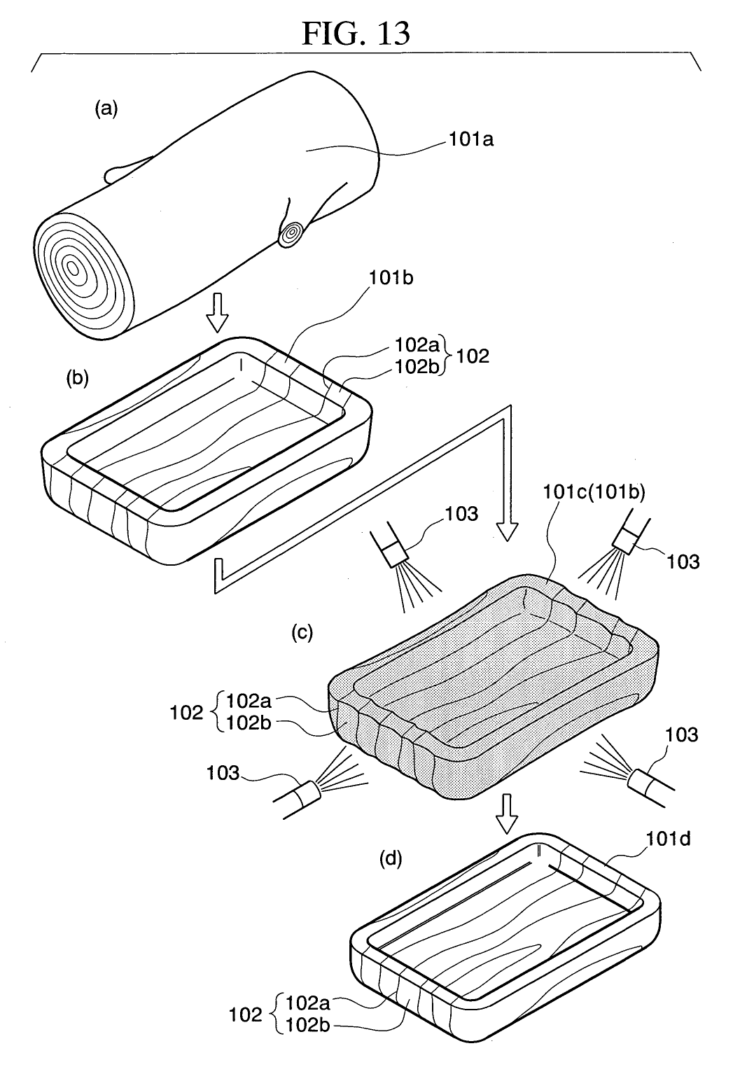

Next, a detailed description is given of second embodiment of the present invention with reference to FIG. 13 through FIG. 16.

First, as shown in step (a) in FIG. 13, a wooden material 101a is a raw wood before processing. The kinds of wooden material 101a are, for example, hinoki (Japanese cypress), paulownia, teak, mahogany, Japanese cedar, pine, cherry, bamboo and the like.

Next, as shown in step (b) in FIG. 13, the wooden material 101a is roughly cut, for example, the wooden material is formed to have a U-shaped section (Roughly cutting step). A pattern of woodgrains 102 appears on the outer surface of a roughly cut wooden material 101b. The woodgrains 102 are composed of striped hard portions 102a which have a high density and are hard to burn, and soft portions 102b which are the other portions having lower density and being easier to burn than the hard portions 102a.

Next, as shown in step (c) in FIG. 13, the wooden material 101b is set at a predetermined position, and a gas burner 103 provided in the vicinity thereof is ignited (Carbonizing step). When the gas burner 103 is ignited, flames are applied onto the surface of the wooden material 101b, whereby the surface of the wooden material 101b is burnt and carbonized. At this time, by relatively moving both the wooden material 101b and the gas burner 103 or any one thereof periodically, the surface of the wooden material 101b can be evenly and uniformly carbonized. Therefore, a wooden material 101c whose surface is carbonized can be obtained.

When the surface of the wooden material 101b is carbonized, the soft portion 102b is burnt and is made into an inwardly caved state from the surface of the wooden material 101c. On the other hand, the hard portion 102a still remains and is made into an outwardly protruding state in contrast to the soft portion 102b, whereby convex and concave portions are produced on the surface of the wooden material 101c due to woodgrains 102. That is, the hard portion 102a having a high density is made convex and the soft portion 102b having a low density is made concave.

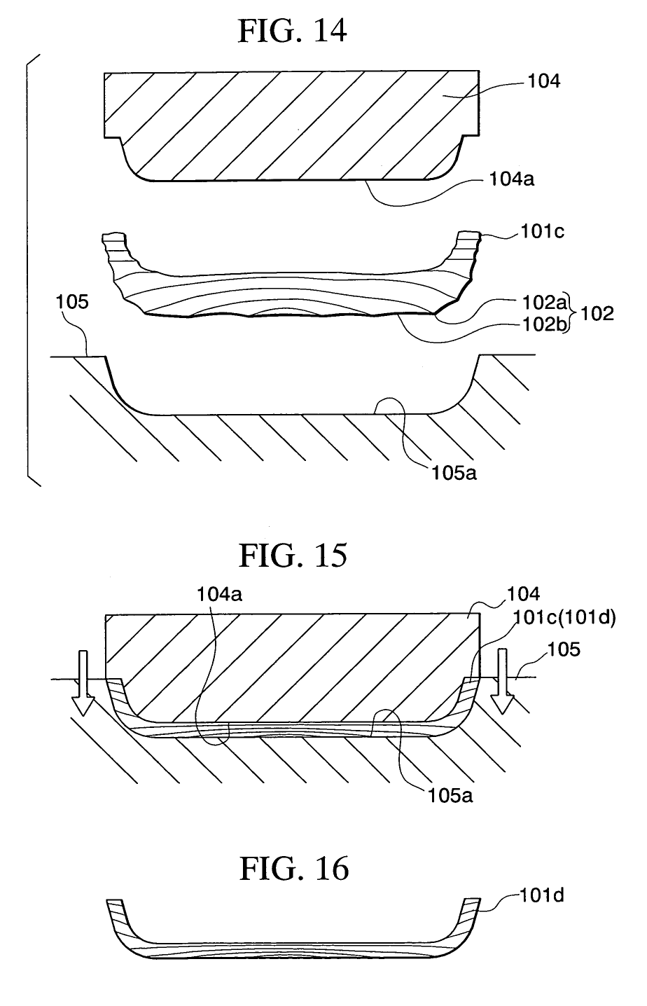

As shown in step (d) in FIG. 13, after the carbonizing step, the wooden material 101c is compressed using dies (compression step). In the compression step, compression is carried out by using a set of dies as shown in FIG. 14 through FIG. 16.

The dies include a lower die 105 and an upper die 104. The upper die 104 is enabled to rise and fall with respect to the lower die 105. A cavity surface 105a that receives the outer surface of the lower portion of the wooden material 101c subjected to the carbonizing step is formed in the lower die 105, and a protrusion portion 104a corresponding to the cavity surface 105a is formed on the upper die 104. Both the protrusion portion 104a and the cavity surface 105a are formed to be smooth, and when the dies are clamped with the protrusion portion 104a placed in the cavity surface 105a, a cavity for the compression process is formed between the protrusion portion 104a and the cavity surface 105a.

In the compression step, first, the wooden material 101c after the completion of a carbonizing step is disposed in an atmosphere of water vapor under high temperature and high pressure. The wooden material 101c after the carbonizing step excessively absorbs moisture by being placed in an atmosphere of water vapor under high temperature and high pressure, and is softened. Next, the wooden material 101c after the completion of the carbonizing step is placed on the cavity surface 105a of the lower die 105 while maintaining an atmosphere of water vapor under high temperature and high pressure. Then, as shown in FIG. 15, as the upper die 104 is caused to fall, the protrusion portion 104a is brought into contact with the outer surface of the upper portion of the wooden material 101c. As the upper die 104 is caused to fall further, the upper die 104 presses the wooden material 101c into the lower die 105, wherein the wooden material 101c nipped between the upper die 104 and the lower die 105 is compressed, including the convex and concave portions produced due to woodgrains 102.

The wooden material 101c is maintained for a predetermined period of time while being compressed, the wooden material 101c is compressed to one-half to one-third of the original thickness. Finally, after released from a high temperature and high pressure water vapor atmosphere, the wooden material 101d after compression is taken out from between the upper die 104 and the lower die 105. The wooden material 101d picked up from the dies is formed to the shape of the cavity brought about when the upper die 104 and the lower die 105 are combined, and at the same time, a concavity and convexity based on woodgrains 102, which are produced on the surface of the wooden material 101c, can be made even.

According to the method for processing the surface of a wooden material according to this embodiment, since the compression step is carried out after the carbonizing step, a concavity and convexity brought about by woodgrains on the surface of the wooden material 101c through the carbonizing step is made even. Therefore, it is possible to obtain a carbonized wooden material 101d whose surface is made smooth. The carbonized wooden material 101d can be used as a material for various types of products while utilizing the characteristics of the wooden material 101a.

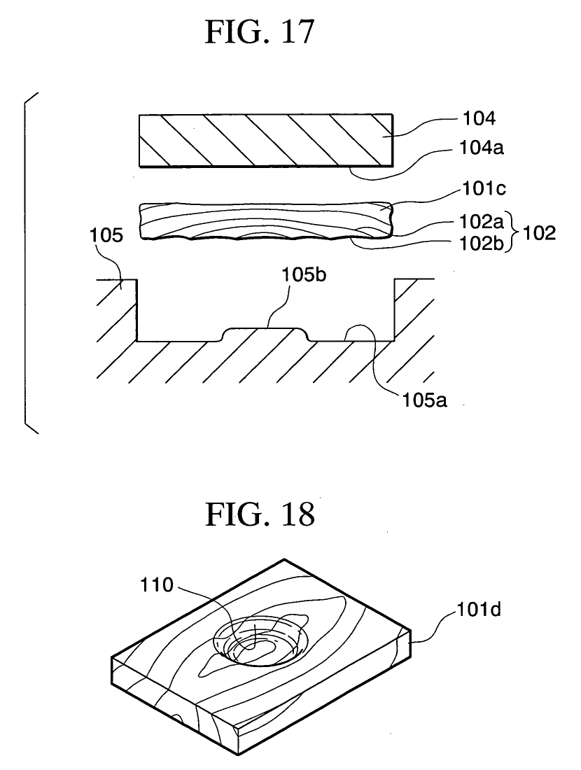

Next, a detailed description is given of third embodiment of the present invention with reference to FIG. 17 and FIG. 18. Note that, in FIG. 17 and FIG. 18, components which are identical to those in FIG. 14 through FIG. 16 are given the same reference numerals, and the description thereof is omitted.

This embodiment basically has the same construction as that of second embodiment. Third embodiment differs from second embodiment only in the following points. That is, in this embodiment, as shown in FIG. 17, the surfaces corresponding to the protrusion portion 104a and the cavity surface 105a are flat. Further, a protrusion portion 105b is provided on the cavity surface 105a. The protrusion portion 105b is formed to be circular when being viewed from above, and is formed to be like a circular arc when being viewed from the side.

In this embodiment, when the wooden material 101c is compressed by the upper die 104 and the lower die 105, the protrusion portion 105b pushes into the wooden material 101c. As shown in FIG. 18, a concavity and convexity brought about by woodgrains 102 are made even on the wooden material 101d obtained after compressing the wooden material 101c, and a circular uneven pattern 10 is produced on the surface of the wooden material 101d.

According to the method for processing the surface of a wooden material according to this embodiment, the surface of the carbonized wooden material 101d varies widely and can be used as a material for various types of products while utilizing the characteristics of the wooden material 101a.

Note that, the protrusion portion 105b is made circular in this embodiment. However, the shape and quantity of the protrusion portion may be adequately varied so that the surface of a wooden material may be stamped, matte finished, or applied various patterns, instead, a recess portion may be provided. n addition, the protrusion portion 105b is provided on the cavity surface 105a of the lower die 105 in this embodiment. However, the protrusion portion may be provided only on the upper die 104, or may be provided on both the upper die 104 and the lower die 105.

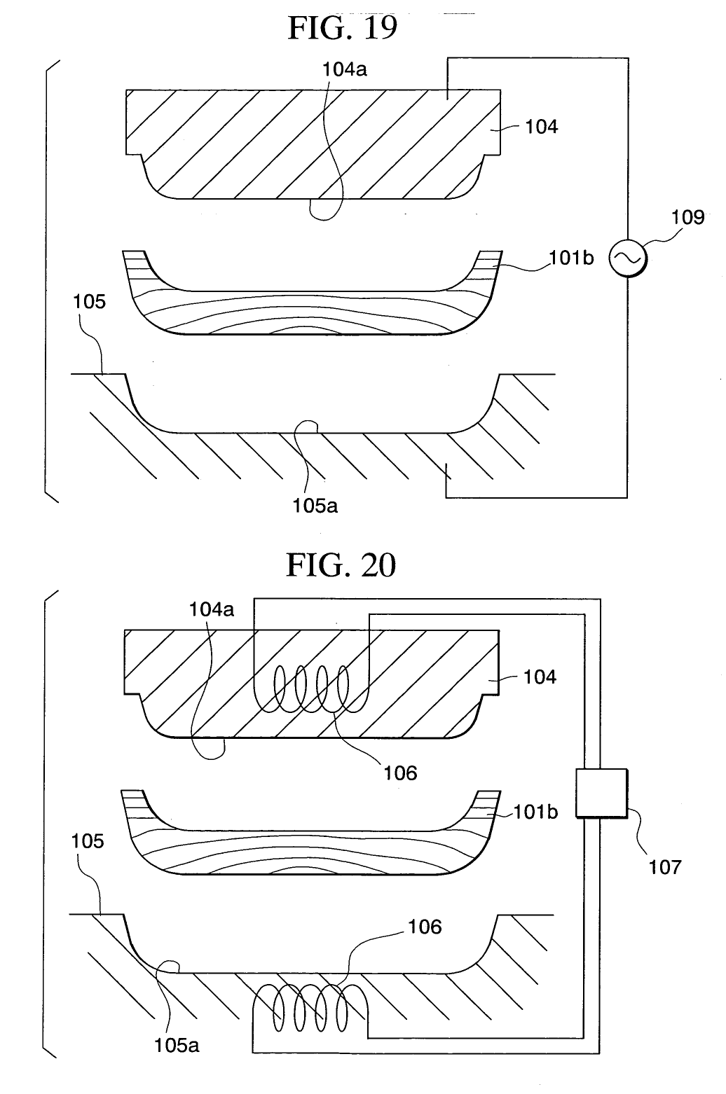

Next, a detailed description is given of fourth embodiment of the present invention with reference to FIG. 19. Note that, in FIG. 19, components which are identical to those described in FIG. 14 are given the same reference numerals, and the description thereof is omitted.

This embodiment basically has the same construction as that of second embodiment. Fourth embodiment differs from second embodiment only in the following points. That is, in this embodiment, as shown in FIG. 19, a high-frequency power supply 109 is connected to the upper die 104 and the lower die 105. When the high-frequency power supply 109 is driven, a high-frequency AC field is generated between the upper die 104 and the lower die 105, a wooden material 101b placed therebetween is heated by high-frequency induction heating. That is, these upper die 104 and lower die 105 function not only as dies for compression but also as electrodes for high-frequency induction heating.

In this embodiment, a roughly-cut wooden material 101b is disposed on the cavity surface 105a of the lower die 105, and the upper die 104 is caused to fall, wherein the wooden material 101b is compressed. At this time, the high-frequency power supply 109 is driven to heat the wooden material 101b by high-frequency induction heating. Therefore, the wooden material 101b is carbonized while maintaining the above-described compressed state.

According to the method for processing the surface of a wooden material of the present invention, since carbonization and compression of the roughly-cut wooden material 101b are carried out at the same time, it is possible to quickly make the concavity and convexity brought about by woodgrains even with the carbonization temperature and compressive force well balanced.

In addition, in this embodiment, high-frequency induction heating is utilized.

However, instead thereof, the dies are formed of a dielectric material such as ceramics, and microwave heating may be utilized.

Next, a detailed description is given of fifth embodiment of the present invention with reference to FIG. 20. Note that, in FIG. 20, components which are identical to those described in FIG. 14 are given the same reference numerals, and the description thereof is omitted.

In this embodiment, as shown in FIG. 20, a heater 106 is incorporated in the surrounding of the cavity in the upper die 104 and the lower die 105. The heater 106 is able to heat the wooden material 101b to a predetermined temperature via a heating device 107. Further, the drive portion (not shown) of the upper die 104 and the heating device 107 are connected to a control unit (not shown). The control unit controls movement of the upper die 104 and operation of the heating device 107. That is, the control unit is able to adjust a compressive force to the wooden material 101b under processing and the temperature of the upper die 104 and the lower die 105.

In this embodiment, a roughly cut wooden material 101b is disposed on the cavity surface 105a of the lower die 105, and as in third embodiment, the wooden material 101b is compressed. At this time, by actuating the heating device 107, the heater 106 generates heat and heats the wooden material 101b via the upper die 104 and the lower die 105. Therefore, the wooden material 101b is carbonized with the above-described compressed state kept. The compressive forces of the upper die 104 and the lower die 105, and the heating temperature thereof are adjusted via the control unit, so that they are made adequate to the type of wooden material.

According to the method for processing the surface of a wooden material according to this embodiment, carbonization and compression of the roughly cut wooden material 101b are carried out at the same time. Further, the surface of the wooden material 101b can be finished to required smoothness for the type of the wooden material 101b while taking the balance between the heating temperature and compressive forces into consideration via the control unit. Therefore, the degree of freedom of setting in processing can be improved, and it becomes possible to easily process the wooden material 101b.

In addition, fourth and fifth embodiments are constructed so that any one of the dies and a wooden material is heated. However, these embodiments are not limited thereto. Both the dies and a wooden material may be heated, or the entirety including the atmosphere surrounding both may be heated.

While preferred embodiments of the present invention have been described and illustrated above, it should be understood that these are exemplary of the present invention and are not to be considered as limiting. Additions, omissions, substitutions, and other modifications can be made without departing from the spirit or scope of the present invention. Accordingly, the present invention is not to be considered as being limited by the foregoing description, and is only limited by the scope of the appended claims.

What is claimed is:

1. A wooden casing which comprises a conductive pattern formed on a surface of a wooden material by carbonizing the surface of the wooden material.

2. The wooden casing according to claim 1, wherein electronic components are connected to the conductive pattern.

3. The wooden casing according to claim 2, wherein a through-hole is formed in the wooden material so as to pass through from one side of the wooden material to the other side thereof, and the electronic components disposed at one side of the wooden material and the conductive pattern formed on the other side thereof are electrically connected to each other through the through-hole.

4. The wooden casing according to claim 1, wherein the wooden material is compressed.

5. A method for processing a surface of a wooden material, comprising the steps of:
carbonizing the surface of the wooden material; and
compressing the wooden material.

6. The method for processing a surface of a wooden material according to claim 5, wherein the step of carbonizing is carried out simultaneously with or after the step of compressing, and a conductive pattern is formed on the surface of the wooden material by carbonizing the surface thereof.

7. The method for processing a surface of a wooden material according to claim 5, wherein the step of compressing is carried out after the step of carbonizing so that a concavity and convexity due to woodgrains, which is produced by carbonizing, is made even.

8. The method for processing a surface of a wooden material according to claim 7, wherein the surface of the wooden material is made smooth through the step of compressing.

9. The method for processing a surface of a wooden material according to claim 6, wherein convex and concave patterns are optionally given to the surface of the wooden material through the step of compressing.

10. The method for processing a surface of a wooden material according to claim 7, wherein convex and concave patterns are optionally given to the surface of the wooden material through the step of compressing.
